(19) United States
(12) Patent Application Publication
(10) Pub. No.: US 2026/0048793 A1
(43) Pub. Date: Feb. 19, 2026

(54) MOTOR VEHICLE WITH A LOAD-BEARING VEHICLE FRAME

(71) Applicant: MAGNA STEYR Fahrzeugtechnik GmbH & Co KG, Graz (AT)

(72) Inventors: Josef MOGG, Hartberg (AT); David LECHNER, Graz (AT)

(73) Assignee: MAGNA STEYR Fahrzeugtechnik GmbH & Co KG, Graz (AT)

(21) Appl. No.: 19/297,355

(22) Filed: Aug. 12, 2025

(30) Foreign Application Priority Data
Aug. 19, 2024 (EP) 24195170.6

(51) Int. Cl. B62D 21/15; B60K 1/04

(52) U.S. Cl. CPC B62D 21/15; B60K 1/04

(57) ABSTRACT

A motor vehicle with a supporting vehicle frame, in which the vehicle frame has a side rail formed, at least in a section along its longitudinal extent, namely in an energy absorber section, by an open C-profile which is open towards the outside of the vehicle. A hollow-chamber profile having a plurality of hollow chambers is accommodated inside the open C-profile at least in some sections.

### CROSS-REFERENCE TO RELATED APPLICATIONS

The present application claims priority under 35 U.S.C. § 119 to European Patent Publication No. EP 24195170.6 (filed on Aug. 19, 2024), which is hereby incorporated by reference in its complete entirety.

### TECHNICAL FIELD

The present disclosure relates to a motor vehicle with a supporting vehicle frame, wherein the vehicle frame has at least one side rail.

### BACKGROUND

It is known to provide motor vehicles with a vehicle frame, in particular with a ladder frame, as a supporting structure. The vehicle frame usually comprises two side rails in the longitudinal direction of the vehicle and for the most part at least two cross rails which connect the two side rails. Side rails are usually formed by profiles with a closed rectangular cross section.

It is known to equip motor vehicles with a drive battery for supplying the required drive energy of an electric or hybrid vehicle. The housing of the drive battery can be arranged between the two side rails of the motor vehicle.

It is known to use aluminum profiles as energy absorbers in order to dissipate the energy in the event of a side impact. They are usually positioned separately laterally, at the outer sides of the vehicle, next to the frame side rails. Side rails and energy absorbers require a relatively large amount of structural space, as a result of which the maximum possible structural space for the integration of a drive battery is reduced. The necessary cross section of the energy absorbers is, however, defined by the required absorption of the energy in the event of a load from a side crash. The usual structure results in very high torsional stiffness of the composite frame in the region of the battery integration. The jumps in stiffness which usually result therefrom at the transition from the battery region to the front end or rear end of the motor vehicle constitute a structural weak point of the supporting vehicle frame.

FIG. 1 illustrates a sectional view of a motor vehicle of the related art, in a region of a side rail 1, with a section through a plane which is normal to the side rail 1 and in the longitudinal direction in a central region of the side rail 1. In this region, central in the longitudinal direction, of the side rail 1 and of the motor vehicle, a drive battery 5 is arranged between the two side rails 1 in the vicinity of the floor of the motor vehicle. The side rail 1 is designed as a closed profile 4, namely, as a rectangular profile with at least one stiffening rib in the interior of the closed profile 4. The drive battery 5 is screwed to the side rail 1. A hollow-chamber profile 3 with a plurality of hollow chambers is arranged laterally next to the profile of the side rail 1. The total space requirement 6 of the side rail 1 and hollow-chamber profile 3 is indicated as an arrow with the reference sign 6.

### SUMMARY

The object of the present disclosure is to specify a motor vehicle with a supporting vehicle frame which reduces at least some of the said problems and in particular has a low structural space requirement and good side impact behaviour. It is intended that a drive battery with a high capacity is integratable or integrated into the supporting vehicle frame.

The object is achieved by a motor vehicle with a supporting vehicle frame, wherein the vehicle frame has a side rail, wherein the side rail is formed, at least in a section along its longitudinal extent, namely in an energy absorber section, by a profile which is open towards the outside of the vehicle, preferably a C-profile, wherein a hollow-chamber profile with a plurality of hollow chambers is accommodated inside the open profile at least in some sections.

In accordance with the present disclosure, a side rail is formed, at least in a section along the longitudinal extent of the motor vehicle, as a profile which is open towards the outside, in particular a C-profile. A hollow-chamber profile with a plurality of hollow chambers is arranged in the cavity formed by the open profile at the outwardly facing side of the profile and therefore inside the C-profile. The hollow-chamber profile extends along the open profile at least in a section, preferably in substantially the whole energy absorber section, in which the open profile is formed.

By virtue of a C-shaped cross section, open towards the outside, of the side rail, it is possible to integrate a hollow profile as a crash profile, preferably formed of aluminium, into the cross section of the side rail, preferably formed of steel. A smaller amount of additional required structural space is necessary because the hollow profile is not arranged laterally next to the side rail and instead is arranged at least in part in the side rail. It is therefore possible with this structure to enlarge the structural space in particular for a battery. This structure results in a lower torsional stiffness in the region of the integration of the hollow profile and preferably of the integration of the battery and therefore also smaller jumps in stiffness at possible transitions to the front end or rear end. The possible harmonization of the stiffness profile constitutes an advantage in terms of a weight-optimized design of the structure.

Considered overall, structural space can be saved compared with previously known solutions and a larger drive battery with at the same time a low weight can be integrated into the motor vehicle.

The open profile is preferably a steel profile. The hollow-chamber profile is preferably an extruded profile. The hollow-chamber profile is preferably formed of aluminium.

The hollow-chamber profile preferably substantially completely fills the open profile in the Z direction of the vehicle, i.e. vertically. The extent of the hollow-chamber profile in the Z direction can, however, also be less than the extent of the open profile in the Z direction. An arrangement of the hollow-chamber profile in the upper, lower or central region of the open profile is advantageous here.

The hollow-chamber profile preferably substantially completely fills the open profile in the Y direction, i.e. in the transverse direction of the vehicle. The hollow-chamber profile is thus pushed into the open profile until it bears directly or indirectly against the profile wall of the open profile. The hollow-chamber profile preferably is approximately the same width as the open profile but can also be configured as less wide. The hollow-chamber profile preferably protrudes in the Y direction of the vehicle towards the outside of the vehicle beyond the open profile and is thus preferably designed as wider than the receiving space of the open profile. The hollow-chamber profile is preferably approximately twice as wide as the open profile.

The hollow-chamber profile preferably substantially completely fills the open profile in the X direction, i.e. in the longitudinal direction of the vehicle, and is thus arranged substantially in the whole region in which the side rail is formed by the open profile.

The side rail is preferably formed by a closed profile, preferably by a rectangular profile, at least in a section along its longitudinal extent, in front of and/or behind the energy absorber section. The closed profile is preferably formed from steel. The closed profile preferably forms a front and/or rear end of the motor vehicle. The closed profile or profiles preferably merges or merge integrally into the open profile or are configured as a single part.

The motor vehicle preferably comprises a drive battery, wherein the drive battery is arranged substantially in the energy absorber section in the longitudinal direction of the motor vehicle. The open profile and the hollow profile are formed in the longitudinal direction preferably at least where, or precisely where, the drive battery is arranged.

The motor vehicle preferably has two identical side rails, wherein the drive battery of the motor vehicle is arranged between the two side rails. The drive battery and the energy absorber sections of the side rails are preferably formed in a central part along the longitudinal extent of the motor vehicle.

Developments of the present disclosure are specified in the dependent claims, the description and the attached drawings.

### DRAWINGS

The present disclosure will be described below by way of example with reference to the drawings.

FIG. 1 illustrates a sectional view of a motor vehicle of the related art, in a region of a side rail, with a section through a plane which is normal to the side rail and in the longitudinal direction in a central region of the side rail.

FIG. 2 illustrates a sectional view of a motor vehicle in accordance with the present disclosure, in a region of a side rail, with a section through a plane which is normal to the side rail and in the longitudinal direction in a central region of the side rail.

FIG. 3 illustrates a side view of the motor vehicle of FIG. 2 from the side.

### DESCRIPTION

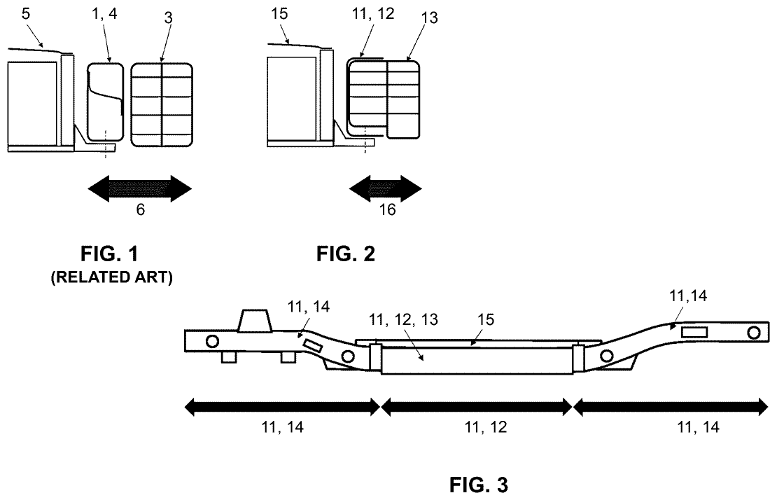

FIG. 2 illustrates a sectional view of a motor vehicle in accordance with the present disclosure. The space requirement 16 of the side rail 11 and hollow-chamber profile 13 together is also indicated in FIG. 2 as an arrow with the reference sign 16 and is substantially less than in the solution of the related art (FIG. 1) because the side rail 11, at least in a section along its longitudinal extent, namely in an energy absorber section, is formed by a profile 12 which is open towards the outside of the vehicle, namely as a C-profile. A hollow-chamber profile 13 with a plurality of hollow chambers is accommodated in the open profile 12.

The hollow-chamber profile 13, which is formed as an aluminum profile, thus lies partially in the interior of the open profile 12 of the side rail 11, which itself is formed of steel. The width of the side rail 11 and the hollow-chamber profile 13 together is thus correspondingly smaller. The savings in structural space can preferably be used as additional structural space for the drive battery 15, which can consequently have a higher capacity.

As illustrated in FIG. 2, the hollow-chamber profile 13 substantially completely fills the open profile 12 in the Z-direction and Y-direction of the motor vehicle. The hollow-chamber profile 13 is designed as wider than the open profile 12, namely, approximately twice as wide as the open profile 12. The hollow-chamber profile 13 protrudes in the Y-direction of the motor vehicle towards the outside of the motor vehicle beyond the open profile 12.

The motor vehicle comprises a drive battery 15 which is accommodated in a battery housing. The drive battery 15 is arranged in the longitudinal direction of the motor vehicle substantially in the energy absorber section, i.e., in a region in which the side rail 11 is formed as the open profile 12, thus, in the middle third of the side rail 11. The drive battery 15, in particular, the housing of the drive battery 15, is fastened, in particularly screwed, to the open profile 12, preferably with the lower limb of the C-profile which extends outwards on the underside of the open profile 12. A fastening section of the drive battery 15 can be arranged below the limb of the C-profile of the open profile 12 and screwed in the overlapping section.

The motor vehicle has a pair of identical side rails 11, in with the drive battery 15 being arranged in the Y-direction between the side rails 11.

FIG. 3 shows the supporting vehicle frame of the motor vehicle in its longitudinal extent, viewed from the side. The side rail 11 is designed as an open C-profile 12 only approximately in its middle third. The side rail 11 is formed by a closed profile, preferably by a rectangular profile, in a section along its longitudinal extent, in front of and/or behind the energy absorber section. There are no energy absorber elements, i.e., no hollow-chamber profiles, arranged on the side rail 11 in these regions, at the front and rear end.

The structural space requirement 16 can be significantly reduced by geometric and functional integration of the hollow profile, i.e., the hollow-profile chamber or crash profile 13, which has the primary function of absorbing crash energy in the event of an accident, into the cross section of the frame side rail 11.

The closed profile cross-section 14 in a C-profile 12 open towards the outside is changed in order to integrate the crash profile 13 into the frame cross section. This is helpful in the region of the crash profile 13. The frame side rail 11 in the region in front of and behind this region, the energy absorber section, can be configured as a closed profile 14.

It is possible to make a larger amount of geometric structural space available for the battery 15 in the transverse direction of the vehicle (Y-direction), with the same vehicle width, by reducing the structural space requirement 16. Associated therewith, it is also possible to decrease the weight of the overall construction or of the supporting vehicle frame.

### LIST OF REFERENCE SYMBOLS

1 side rail
2 open profile
3 hollow-chamber profile
4 closed profile
5 drive battery
6 space requirement

What is claimed is:

1. A motor vehicle, comprising:
a supporting vehicle frame having a side rail with an energy absorber section arranged along a longitudinal thereof, the energy absorber section formed as an open profile towards an outside of the motor vehicle; and
a hollow-chamber profile having a plurality of hollow chambers accommodated in the open profile.

2. The motor vehicle of claim 1, wherein the open profile comprises a C-profile.

3. The motor vehicle of claim 1, wherein the plurality of hollow chambers are accommodated at least in some sections of the open profile.

4. The motor vehicle of claim 1, wherein the open profile is formed from steel.

5. The motor vehicle of claim 4, wherein the hollow-chamber profile is an extruded profile.

6. The motor vehicle of claim 5, wherein the hollow-chamber profile is formed of aluminum.

7. The motor vehicle of claim 1, wherein the hollow-chamber profile substantially fills the open profile in a Z-direction of the motor vehicle.

8. The motor vehicle of claim 1, wherein the hollow-chamber profile substantially fills the open profile in a Y-direction of the motor vehicle.

9. The motor vehicle of claim 1, wherein the hollow-chamber profile substantially fills the open profile in an X-direction of the motor vehicle.

10. The motor vehicle of claim 1, wherein the hollow-chamber profile protrudes in a Y-direction of the motor vehicle towards an outside of the motor vehicle beyond the open profile.

11. The motor vehicle of claim 1, wherein the hollow-chamber profile has a width that is two times greater than a width of the open profile.

12. The motor vehicle of claim 1, further comprising a drive battery.

13. The motor vehicle of claim 12, wherein the drive battery is arranged in the energy absorber section in the longitudinal direction of the motor vehicle.

14. The motor vehicle of claim 12, further comprising a second side rail with a second energy absorber section arranged along a longitudinal thereof, the second energy absorber section formed as an open profile towards the outside of the motor vehicle.

15. The motor vehicle of claim 12, wherein the drive battery is arranged between the side rail and the second side rail.

16. A motor vehicle, comprising:
a supporting vehicle frame having a side rail with an energy absorber section arranged along a longitudinal thereof, the energy absorber section formed as a closed profile in a front region of the motor vehicle;
a hollow-chamber profile having a plurality of hollow chambers accommodated in the open profile; and
a drive battery arranged in the energy absorber section in the longitudinal direction of the motor vehicle.

17. The motor vehicle of claim 16, wherein the closed profile comprises a rectangular profile.

18. The motor vehicle of claim 16, further comprising a second side rail with a second energy absorber section arranged along a longitudinal thereof, the second energy absorber section formed as a closed profile in a front region of the motor vehicle.

19. The motor vehicle of claim 18, wherein the drive battery is arranged between the side rail and the second side rail.

20. A motor vehicle, comprising:
a supporting vehicle frame having a side rail with an energy absorber section arranged along a longitudinal thereof, the energy absorber section formed as a closed profile in a rear region of the motor vehicle; and
a hollow-chamber profile having a plurality of hollow chambers accommodated in the open profile.
